(19) United States
(12) Patent Application Publication
(10) Pub. No.: US 2011/0305983 A1
(43) Pub. Date: Dec. 15, 2011

(54) Release Agent for Toner, and Toner

(75) Inventors: Seiji Kounou, Hyogo (JP); Koji Morimoto, Hyogo (JP); Kenji Nasu, Hyogo (JP); Takenori Fujimura, Chiba (JP)

(73) Assignees: IDEMITSU KOSAN CO., LTD., Tokyo (JP); SEIKO PMC CORPORATION, Tokyo (JP)

(21) Appl. No.: 13/203,087

(22) PCT Filed: Feb. 8, 2010
(86) PCT No.: PCT/JP2010/000753

§ 371 Date: Aug. 24, 2011

(30) Foreign Application Priority Data
Feb. 25, 2009 (JP) 2009-041934
Apr. 22, 2009 (JP) 2009-104222
Apr. 24, 2009 (JP) 2009-105884

(51) Int. Cl. G03G 9/16; C08F 255/00

(52) U.S. Cl. 430/108.1; 525/333.7

(57) ABSTRACT

The objectives of the present invention are attained with a release agent for toner that is obtained by grafting styrene compounds to an α-olefin polymer that conforms to the following conditions (a) and (b), wherein 70 mass % or more of the release agent is insoluble in 2-butanone when the release agent is dispersed at 25° C. into 2-butanone so that the mass ratio of the release agent to the dispersion is 15%. (a) The α-olefin polymer is to be produced by polymerization of at least one α-olefin monomer that has 16 or more to 36 or less carbon atoms. (b) The α-olefin polymer is to have a melting point between 30° C. or higher and 80° C. or lower, and has one peak temperature whose peak has the half-height width of 15° C. or less in a measurement of the melting behavior of the α-olefin polymer by means of differential scanning calorimetry.

### TECHNICAL FIELD

The present invention concerns a toner and a release agent for toner, more specifically, the toner that is employed in the development of an electrostatic charge image in electrophotography or electrostatic printing, and is suitable for electrophotography or electrostatic printing, and the release agent that is employed for the production of such toner.

### BACKGROUND ART

Nowadays the energy saving design is important in the development of image forming devices such as copy machines and printers. Sixty percent of the total electric power consumed by a copy machine is actually consumed by the toner-fixing unit. Therefore the reduction of the power consumption by the unit is expected to greatly contribute to energy saving. The fixing unit normally employs a mechanism represented by a hot roll fixing method in which a hot roll applies heat and pressure for image fixing. In the mechanism, how to fix the toner at a low temperature, in other words, the properties of the toner suited for a low temperature image fixing, is technologically crucial to attain the reduction of the power consumption. At the same time, in the hot roll fixing method, melting toner contacts the surface of the hot roll. Therefore a hot-offset, in which the next receptive sheet is contaminated by the toner that has been transferred and clung to the hot roll then is re-transferred to the next sheet, must be prevented from taking place as well. Moreover the toner is required to have anti-blocking properties during its storage and transportation in order to attain a long life and preservability.

Given an excessive low temperature fixing property to the toner, however, it is more vulnerable to blocking that takes place while the toner is used in a high temperature or left stored for a long period of time, and allows the problem of low preservability to arise. In toner design, in which low temperature image fixing and high preservability are two conflicting properties, the balance between the properties must be taken into account. Another property that must be taken into consideration in the toner design is the removability with which the toner may be properly removed from the fixing roll without compromising its image fixing property on the receptive sheet.

In order to meet the above mentioned requirements, the toner designs, in which the glass transition of the binding agent is lowered, resins with low melting points and/or low molecular weight resins are contained in the binding agent, or low softening point materials with a good releasability or removability is contained in the toner, have been proposed.

Conventionally, the low softening point materials with a good releasability or removability are often called release agent for toner. Polyethylene waxes and polypropylene waxes have been widely used as the release agent. The melting points of the waxes, however, are not low enough to meet the requirement of the low temperature image fixing, then recently the application of carnauba wax, ester type wax, or α-olefin polymer, all of which have even lower melting points, for release agent was proposed (See patent documents 1 to 8). Nevertheless in the current situation of the ever more growing demand for energy efficiency and for a high quality of images created by image forming devices, the dispersibility and anti-blocking property of the release agent are required to be further improved.

It has been well known that the improvement of the dispersibility and anti-blocking property may be attempted by means called modification, such as vinyl modification represented by acrylic resin modification, styrene-acrylic resin modification and styrene resin modification, and acid modification, which modify the properties of the natural waxes or synthesized waxes employed as or contained in the release agent for toner (See patent documents 9 to 12 for some examples). Patent document 9 discloses that acid modified waxes used as the release agent in a toner were found to improve the anti-blocking properties of the toner, but the removabilities of the toner were compromised and the anti-hot-offset properties of the toner were likely to be poorer than the anti-hot-offset properties of another toner with non-modified waxes. The modification with vinyl monomers, which is disclosed in patent document 10, causes a phase separation of the modified waxes in molten state because the modification rate of the monomers was low, then non-modified waxes were likely to be produced as well as polymers polymerized by vinyl monomers that were not chemically bonded to the waxes. The document also discloses that sometimes the polymers produced by polymerization of vinyl monomers with low molecular weight without bonding to the waxes were recognized to act as plasticizers or adhesives to develop insufficient anti-hot-offset properties and anti-blocking properties. Waxes modified by polystyrene-resin have excellent compatibilities with carbon black in the toner as well as with the binding agents in the toner, because the binding agents are rich in compounds having aromatic rings (See patent document 11 and 12). With the recent advancement of polyester as binding agents, however, waxes modified by polystyrene resin is often insufficient for compatibility with polyesters and insufficient anti-blocking property of toner. Therefore a toner should be further improved.

### PRIOR ART DOCUMENTS

### Patent Documents

Patent document 1: JP2000-242041A
Patent document 2: JP2003-295499A
Patent document 3: JP2007-206250A
Patent document 4: JP2007-271932A
Patent document 5: JP2007-271934A
Patent document 6: JP2007-271939A
Patent document 7: JP2008-170538A
Patent document 8: JP2008-268289A
Patent document 9: JP07-281478A
Patent document 10: JP2008-031434A
Patent document 11: JP58-63947A
Patent document 12: JP63-191817A

### SUMMARY OF INVENTION

### Technical Problem

The objective of the present invention is to provide the toner that affords the above-mentioned properties to be employed in the development of an electrostatic charge image in electrophotography or electrostatic printing, and is suitable for electrophotography or electrostatic printing, and to provide the release agent that is employed for the production of such toner.

### Solution to Problem

One means to attain the objectives of the present invention is (1) A release agent for toner that is obtained by grafting styrene compounds to α-olefin polymer that conforms to the following conditions (a) and (b), wherein 70 mass % or more of the release agent is insoluble in 2-butanone when the release agent is dispersed at 25° C. into 2-butanone so that the mass ratio of the release agent to the dispersion is 15%.

(a) The α-olefin polymer is to be produced by polymerization of at least one α-olefin monomer that has 16 or more to 36 or less carbon atoms.
(b) The α-olefin polymer is to have a melting point between 30° C. or higher and 80° C. or lower, and has one peak temperature whose peak has the half-height width of 15° C. or less in a measurement of the melting behavior of the α-olefin polymer by means of differential scanning calorimetry (DSC).

Other means are

(2) The release agent for toner described in (1), wherein said release agent has a melting point between 30° C. or higher and 80° C. or lower, and has one peak temperature whose peak has the half-height width of 15° C. or less in a measurement of the melting behavior of the agent by means of differential scanning calorimetry (DSC), and
(3) A toner comprising the release agent for toner described in (1) or (2), wherein the mass ratio of the release agent to the solid content of a biding agent is between 0.1 mass % and 40 mass %.

### Advantageous Effects of Invention

The present invention can provide the release agent for toner that afford the toner having an enhanced anti-hot-offset property without compromising the low temperature fixing property, a wide non-offset range, an excellent anti-blocking property, and an excellent dispersibility of release agent. The present invention can also provide the toner that has an enhanced anti-hot-offset property without compromising the low temperature fixing property, a wide non-offset range, an excellent anti-blocking property, and an excellent dispersibility of release agent. The image forming devices employing such toner can save energy and produce images with a high quality.

### BRIEF DESCRIPTION OF THE DRAWING

FIG. 1 shows a trace produced by a melting behavior observation with a differential scanning calorimeter demonstrating how to determine the melting point (Tm) and the half-height width of a peak for melting point.

### DESCRIPTION OF EMBODIMENTS

The present invention is explained in detail as follows.

The α-olefin polymer, which is an ingredient for the release agent of the present invention, contains a monomer unit of α-olefin having 16 or more to 36 or less carbon atoms. The mol ratio of the α-olefin as monomer unit, whose number of the carbon atoms is between 16 or more and 36 or less, favorably 18 or more and 34 or less, more favorably 18 or more and 32 or less, to the α-olefin polymer is favorably between 50% or more and 100% or less, more favorably 70% or more and 100% or less, even more favorably 85% or more and 100% or less, and most favorably 100%. The α-olefin polymer that contains no α-olefin having 16 or more to 36 or less carbon atoms as a monomer unit has a poorer compatibility with various substances because of its too high melting point. One or more α-olefins are selected for use from the following examples of the α-olefins having 16 or more to 36 to less carbon atoms. The examples are 1-hexadecene, 1-heptadecene, 1-octadecene, 1-nonadecene, 1-eicosene, 1-henicosene, 1-docosene, 1-tricosene, 1-tetracosene, 1-pentacosene, 1-hexacosene, 1-heptacosene, 1-octacosene, 1-nonacosene, 1-triacontene, 1-hentriacontene, 1-dotriacontene, 1-tritriacontene, 1-tetratriacontene, 1-heptatriacontene and 1-hexatriacontene. The α-olefin polymer that is the ingredient for the release agent for toner of the present invention containing only α-olefins as monomer units with less than 16 carbon atoms is so hard to be crystallized that the polymer and its styrene type modification as well as the toner are too sticky with lowered melting points. Nonetheless the α-olefins including 1-decene, 1-undecene, 1-dodecen, 1-tridecene, 1-tetradecene, and 1-pentadecene, which do not belong to the α-olefins having 16 or more to 36 or less carbon atoms, may be employed as long as such α-olefins do not inhibit the advantages of the present invention.

The α-olefin polymer, which is the ingredient for the release agent of the present invention, contains as the monomer units α-olefins which have 16 or more to 36 or less carbon atoms, and conforms to the condition (1) below, preferably further conforms to all the conditions (1), (2) and (3).

(1) The α-olefin polymer is to have a melting point between 30° C. or higher and 80° C. or lower, and has one peak temperature whose peak has the half-height width of 15° C. or less in a measurement of the melting behavior of the α-olefin polymer by means of differential scanning calorimetry (DSC).
(2) The α-olefin polymer is to have the weight-average molecular weight (Mw) determined by means of gel permeation chromatography (GPC) between 1,000 and 10,000,000.
(3) The α-olefin polymer is to have the molecular weight distribution (Mw/Mn) determined by means of gel permeation chromatography (GPC) is 5.0 or less.

The α-olefin polymer of the present invention has a melting point between 30° C. or higher and 80° C. or lower, favorably 40° C. or higher and 80° C. or lower, more favorably 50° C. or higher and 80° C. or lower. The α-olefin polymer of the present invention meeting the above mentioned conditions and its styrene type modifications, then naturally, the toner are seldom too sticky at ordinary temperature, revealing excellent stability during storage and processability for secondary application, as well as their own excellent processabilities because they melt evenly at a low temperature.

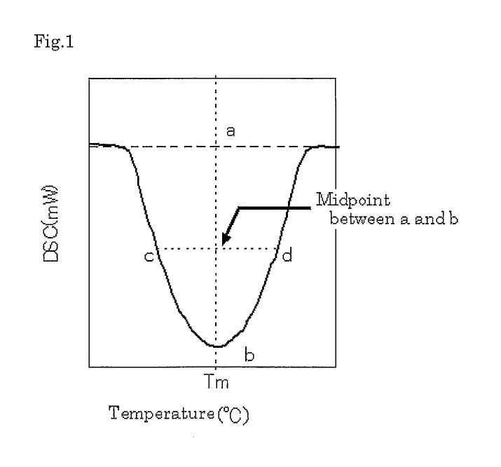

The melting point (Tm) of the α-olefin polymer of the present invention is determined with a differential scanning calorimeter (DSC. EXSTAR6000 produced by SII NanoTechnology Inc). 10 mg of the α-olefin polymer as a sample is retained in a nitrogen atmosphere at −10° C. for 5 minutes, then heated at 10° C./min up to 190° C. at which the sample is retained for 5 minute to be subsequently cooled down at 5° C./min to −10° C. at which the sample is retained for 5 minutes. The subsequent heating of the sample at 10° C./min up to 190° C. produces the only one melting point (Tin) recognized as a peak top. A substantially flat base line in the range of temperature higher than the melting point is extended towards the lower temperature range. The extended line parallel to the x-axis makes an intersection (point “a” in FIG. 1) with the line representing the formula of x=Tm. The peak width (the distance between point c and d in FIG. 1, the half height width), which includes the midpoint of the distance between the intersection and the peak top (point b in FIG. 1) is 15° C. or less.

The weight average molecular weight (Mw) of the α-olefin polymer of the present invention determined with GPC is favourably between 1,000 and 10,000,000, more favourably 5,000 and 10,000,000. With a Mw less than 1,000 the α-olefin polymer has inferior strength and with a Mw over 10,000,000 the excessively high melt viscosity hampers the processing and kneading of the polymers. Additionally the molecular weight distribution (Mw/Mn) of the α-olefin polymer of the present invention determined with GPC is favourably 5.0 or less, more favourably between 1.0 or more and 3.5 or less, most favourably between 1.0 or more and 3.0 or less. The toner including the α-olefin polymer with too wide distribution (Mw/Mn) over 5.0 and its styrene type modifications may occasionally have deteriorated surface property, namely the induced excessive stickiness and inferior strength.

The above mentioned molecular weight distribution (Mw/Mn) is sought from the polystyrene calibrated weight average molecular weight (Mw) and number average molecular weight (Mn) determined by GPC with the apparatus under the conditions listed below.

### The GPC Measurement Apparatus

### Column: TOSO GMHHR-H (S) HT

Detector: RI detector for liquid chromatography WATERS 150C

### The Measurement Conditions

Solvent: 1,2,4-trichloro benzene
Measurement temperature: 145° C.
Flow rate: 1.0 ml/min
Sample concentration: 2.2 mg/ml

### Dosage: 160 μl

Calibration curve: Universal Calibration
Analysis program: HT-GPC (Ver. 1.0)

Catalysts, the ones disclosed in WO2003/07079 for example, may be favorably used for the production of α-olefin polymer of the present invention.

The styrene compounds that are grafted onto the α-olefin polymer of the present invention are exemplified by styrene and its derivatives having the styrene backbone. (For reference, generally these compounds are called “styrene backbone contained compounds.”) Each styrene backbone contained compound has a double bond that is bonded to the benzene ring and has enough polymerization reactivity to be adequately grafted onto the α-olefin polymer of the present invention. Examples of the styrene compounds are styrene, α-methylstyrene, divinylbenzene, 4-methylstyrene, 4-t-butylstyrene, 4-n-octylstyrene, sodium styrenesulfonate, 4-vinylbenzoic acid, 4-aminostyrene, 4-methoxystyrene, 4-nitrostyrene, stilbene, and 4.4′-dimethylstilbene, of all which styrene is the favorable example. In grafting the styrene compounds onto the α-olefin polymer, more than one kind of styrene compounds can be used in graft-polymerization.

The amount of styrene compounds grafted onto the α-olefin polymer of the present invention may be determined according to the required properties of the toner, and accordingly is favorably between 10 mass % or more and 50 mass % or less, more favorably 15 mass % or more and 40 mass % or less based on the mass of the α-olefin polymer. Too small an amount of the grafted styrene compounds, namely 10 mass % or less, renders the release agent for toner to have properties similar to non-grafted α-olefin polymer that has a narrow non-offset range, although the release agent has an increased amount of component non-soluble in 2-butanone. On the contrary, too much an amount of the grafted styrene compounds, namely more than 50 mass % or more, reduces the amount of the component soluble in 2-butanone occasionally to less than 70 mass %. Too little component insoluble in 2-butanone affects the properties of the toner, which is rendered to have inferior anti-blocking and anti-hot-offset properties.

In order to graft the styrene compounds onto the α-olefin polymer, graft polymerization initiators capable hydrogen abstraction, exemplified by the organic peroxides disclosed in JP2006-052246A, are preferably employed. Among the initiators, dicumyl peroxide and di-t-butyl peroxide are specifically favored. Each of the initiators may be used not only on its own but also in the combination with other initiators. Other radical polymerization initiators than said organic peroxides, such as AIBN, redox type radical initiators, and photopolymerization initiators, may be also employed to the extent that the initiators do not inhibit the advantages of the present invention.

The preferable amount of the employed organic peroxides is between 0.1 mass % or more and 10 mass % or less, more preferably 0.2 mass % or more and 5 mass % or less, based on the amount of the styrene. With the amount between 0.1 mass % or more and 10 mass % or less, the styrene compounds have more enhanced reactivity than with the amount of less than 0.1 mass %, and the radicals coming from the organic peroxides are less encouraged to sever the polymer chains favorably reducing the amount of low molecular weight component, which would affect the properties of the toner, than with the amount of more than 10 mass %. The amount between 0.2 mass % or more and 5 mass % or less is even preferable because of the further reduced amount of the low molecular components.

In order to control the stability of the release agent for toner of the present invention, stabilizers may be added into the release agent according to the specific objectives of the application. The stabilizers are exemplified by conventional compounds like hydroquinone, benzoquinone, nitrosophenylhydroxy compounds, such phosphite compounds as tris (2,4-di-t-butylphenyl) phosphite and such pentaerythritol ester compounds as pentaerythrityl-tetrakis [3-(3,5-di-t-butyl-4-hydroxyphenyl)propionate].

In view of the VOC regulations, the use of organic solvent should be preferably avoided in grafting styrene compounds onto the α-olefin polymer. When the use of organic solvents is inevitable, however, such organic solvents are exemplified by aromatic hydrocarbons having no ethylenic double bonds like toluene and xylene, saturated aliphatic hydrocarbons like hexane, heptane and octane, saturated alicycle hydrocarbons like cyclohexane, methylcyclohexane, ethylcyclohexane, cycloheptane and methylcycloheptane, esters having no ethylenic double bonds like ethyl acetate, n-butyl acetate and isobutyl acetate, ketones having no ethylenic double bonds like acetone, 2-butanone, methyl isobutyl ketone and cyclohexanone, ethers having no ethylenic type double bonds like n-butyl ether, isobutyl ether, tetrahydrofuran, diethylether, ethyleneglycoldialkylether and dioxane. Each of the organic solvents may be used on its own as well as in the combination of the other organic solvents.

When the organic solvents are used in the method of grafting the styrene compounds onto the α-olefin polymer, the smaller the amount of the solvents is, the more preferable. The maximum amount of the solvent is 300 mass % of sum total amount of styrene compounds and α-olefin polymer combined. The amount of organic solvents more than 300 mass % is unfavorable because the styrene compounds and α-olefin polymer are diluted to reduce the efficiency of the addition reaction.

Our investigation confirmed that the α-olefin polymer and α-olefin polymer with grafted styrene compounds are insoluble in 2-butanone at 25° C. with the concentration of 15 mass %, while the styrene compounds that are not grafted onto the α-olefin polymer are soluble. In other words, the insoluble components in 2-butanone is α-olefin polymer and α-olefin polymer with the grafted styrene compounds, and the soluble components in 2-butanone is free styrene compounds, which have failed to be grafted, and the polymerized styrene compounds with low molecular weight. A large amount of the soluble components in 2-butanone means a lowered image fixing temperature, but it also means inferior anti-hot-offset properties, anti-blocking properties and dispersibility of the release agent. The release agent for toner of the present invention with its own high grafting ratio produce 70 mass % or more of the insoluble components in 2-butanone in 25° C. with the concentration of 15 mass %. In view of the required properties and facilitated operation in production, 80 mass % or more of the insoluble components in 2-butanone is preferable. For reference, the 15 mass % means the mass ratio between the release agent for toner and the 2-butanone combined with the release agent for toner.

A melting point of the release agent for toner of the present invention can be measured by means of a differential scanning calorimeter (DSC. EXSTAR6000 produced by SII NanoTechnology Inc) with 10 mg of the sample retained in a nitrogen atmosphere at −10° C. for 5 minutes, then heated at 10° C./min up to 190° C. at which the sample is retained for 5 minutes to be subsequently cooled down at 5° C./min to −10° C. at which the sample is retained for 5 minutes to be subsequently heated at 10° C./min up to 190° C. The release agent for toner of the present invention has the only one melting point (Tm) recognized as a peak top according to the measurement by means of DSC. A subsequently flat base line in the range of temperature higher than the melting point is extended towards the lower temperature range. The extended line parallel to the x-axis, makes an intersection (point “a” in FIG. 1) with the line representing the formula of x=Tm. The peak width (the distance between point “c” and “d” in FIG. 1, the half height width), which includes the midpoint of the distance between the intersection and the peak top (point “b” in FIG. 1) is preferably 20° C. or less.

The release agent for toner of the present invention has following properties. The melting point is between 30° C. and 80° C. In view of the properties of the toner, the preferable melting point is between 50° C. and 80° C. The average molecular weight is preferably between 1,000 and 10,000,000, more preferably 5,000 and 10,000,000.

The toner of the present invention contains at least binding agents and the release agent for toner of this invention. Various additives like colouring agents, magnetic substances and release agent for toner except the release agent for toner of the present invention (hereafter, the release agent for toner except the release agent for toner of the present invention may be referred to simply as “release agent”), charge control agents and surface control agents may be also contained whenever they are necessary. When the release agent for toner of the present invention are applied to toners for electrophotography, the content of the release agent in the toner is between 0.1 mass % and 40 mass %, preferably 1 mass % and 30 mass % based on the mass of the solid content of the binding agents.

No specific limitation is found on the selection of conventional dyes or pigments that may be contained in the toners of the present invention. The specific examples of the colouring agents are carbon black, Sudan black SM, fast yellow G, benzidine yellow, pigment yellow, India fast orange, pigment red, irgazin red, p-nitroaniline red, toluidine red, carmine, pigment orange R, lake red 2G, rhodamine FB, rhodamine B lake, methyl violet B lake, phthalocyanine blue, pigment blue, brilliant green, phthalocyanine green, oilyellow GG, kayaset YG, orasol blown B, oilpink OP, magnetite and iron black. When the employed colouring agents are dyes or pigments, the preferable content of the agents is between 0.5 mass % or more and 15 mass % or less based on the mass of the solid content of the biding agents. When the toner is a magnetic toner, the employed fine powder magnetic materials make the colouring agents content between 20 mass % or more and 150 mass % or less preferable.

The binding agents that may be contained in the toner of the present invention are exemplified by polystyrene homopolymer, styrene copolymers, polyvinylchloride, phenol resins, natural-resin-modified phenol resins, natural-resin-modified maleic acid resins (meth)acrylic resins, polyvinyl acetate, silicon resins, polyester resins, polyurethane resins, poplyamide resins, furan resins, epoxy resins, xylene resins, polyvinyl butyral, terpene resins, cumarone-indene resins, petroleum resins, crosslinked styrene copolymers and composite resins of styrene-acrylic copolymers and polyester resins.

Whenever they are required, other release agents than the release agent for toner of the present invention may be jointly used as the release agents that may be the components contained in the toner of the present invention within the said range of the content of the release agent for toner of the present invention as long as their presence in the toner does not inhibit the expected properties of the release agent for toner of the present invention. The jointly used release agents are exemplified by such polyolefin resins as polypropylene, polyethylene, copolymers of ethylene and α-olefins with three or more to eight or less carbon atoms and α-olefin polymers, such paraffins as n-paraffins and iso-paraffins, such ester waxes as carnauba wax, montan wax, and rice waxes, aliphatic alcohols with thirty and more carbon atoms, aliphatic acids with thirty and more carbon atoms, and their mixture. One or more of the above mentioned other release agent may be selected for the combined use.

The charge control agents that may be the components contained in the toner of the present invention are not restricted to specific agents and exemplified by nigrosine dyes, quarternary ammonium salt compounds, metal containing azo dyes, metal salicylates, quarternary ammonium salt containing polymers, fluorine containing polymers, sulfonate group containing polymers, and halogen substituted aromatic ring containing polymers. The preferable content of the charge control agents in the toner is between 0 mass % and 10 mass % based on the mass of the solid content of the binding agents.

The surface control agents that may be the components contained in the toner of the present invention are not restricted to specific agents and exemplified by such various fine powders as of colloidal silica, alumina, titanium oxide, polytetrafluoroethylene, polyvinylidene chloride, polymethyl methacrylate, ultra-fine polystyrene particles, and silicone. The preferable content of the surface control agents in the toner is between 0.1 mass % or more and 20 mass % or less based on the mass of the solid content of the binding agents.

The toner of the present invention, in which the additives may be contained, may be manufactured with conventional methods. For example, such dry methods as kneading pulverization (hereinafter, the toner produced by a dry method is designated as dry toner) and such wet methods, in which granulation is conducted in aqueous media, as direct polymerization, suspension polymerization, emulsion polymerization, emulsion association polymerization, seed polymerization, emulsion aggregation, and suspension granulation (hereinafter, the toner produced by the wet method is designated as wet toner) may be proposed.

One example of the method for manufacturing the toner of the present invention by means of the kneading pulverization among other dry methods is to be described. Firstly, release agent containing the release agent for toner of the present invention, binding agents, colouring agents, and the other agents whenever they are required are mixed in a power mixer to be subsequently melted at the temperature between 100° C. or higher and 200° C. or lower, and kneaded by a kneading machine like a hot roller, an extruder, or a kneader in order to fully mix each components with the other components. The mixed composition is cooled down and grinded, then the resulting particles are classified according to the particle size to obtain the particles with the volume average diameter between 2 μm and 15 μm. The obtained toner particles are mixed with the surface control agents by means of powder mixing to produce a toner like a toner for electrophotography.

One example of the method for manufacturing the toner of the present invention by means of the suspension polymerization among other wet methods is to be described. A suspension polymerization is conducted by mixing dispersion stabilizers, polymerizable monomer as the ingredient for forming of the binding agent, polymerization initiators, release agent including the release agent for toner of the present invention, the coloring agents, and the other additives like other binding agents whenever they are required, in such medium, which dissolves very little polymerizable monomer, as water. After the polymerization, the solid content of the product is separated from the liquid content, washed, dried, and classified according to the particle size to provide toner particles. Addition of the surface control agents to the particles provides a toner in particles with the volume average diameter between 2 μm and 15 μm like a toner for electrophotography. Inorganic compounds may be employed as said dispersion stabilizers. The inorganic compounds are exemplified by such phosphates as calcium phosphate and magnesium phosphate, such carbonates as calcium carbonate and magnesium carbonate, such inorganic hydroxides as calcium hydroxide and magnesium hydroxide, and such inorganic compounds as calcium meta-silicate, calcium sulfate, barium sulfate, silica, bentonite, and alumina. Organic compounds may be also employed as said surface control agents. The organic compounds are exemplified by such water soluble polymers as polyvinyl alcohol, methylcellulose, and gelatine, and such surfactants as anion surfactants, cation surfactants, nonion surfactants, and amphoteric surfactants. One or more of the dispersion stabilizers, whether they are inorganic or organic, may be selected for a combined use. Dispersions of fine particles of water-insoluble inorganic compounds like calcium phosphate is preferred because it is easily prepared by metathesis reaction and it more likely provides a toner in finer particles as the final product. The amount of said added dispersion stabilizers is preferably between 0.1 mass % or more and 20 mass % or less, more preferably between 0.2 mass % or more and 10 mass % or less of the polymerizable monomers.

The binding agents employed in the wet toners may be prepared by the polymerization of the polymerizable monomers as the ingredient for the formation of the binding agent resin with the polymerization initiators. Alternatively, instead of, or in combination of, such binding agent resins, said resins or polymers mentioned as the examples of the binding agents may be employed. The polymerizable monomers are exemplified by such styrene compounds as similar compounds having skeletal structure of styrene, such olefins as ethylene, propylene, and vinyl chloride, vinyl acetate and such methacrylates and acrylates as methacrylate, methyl methacrylate, butyl acrylate and butyl methacrylate. Additionally, said similar compounds having skeletal structure of styrene may be exemplified by the already mentioned examples of the similar compounds having skeletal structure of styrene that is grafted to the α-olefin polymer. One or more of the polymerizable monomers may be selected for a combined use. The polymerization initiators that may be employed in the polymerization of the composition containing more than two of the polymerizable monomers may be exemplified by such persulfates as sodium persulfate and ammonium persulfate, such azo compounds as 2,2′-azobis-isobutyl valeronitrile, dimethyl-2.2′-azobis-(2-methyl propionate), and 2,2′-azobis-(2-methyl propione amidine) dihydrochloride, such organic peroxides as dicumylperoxide and di-t-butylperoxide, and such photo polymerization initiators as 1-hydroxy-cyclohexyl-phenyl ketone and 2.2′-dimethoxy-1,2-diphenyl-1-one. One or more of the initiators may be selected for a combined use. Alternatively, redox type radical initiators that are the combination of said initiators and reductants may be employed. The reductants are exemplified by inorganic reductants like Fe²⁺ containing salts and NaHSO₃, and organic reductants like alcohols and polyamines.

One example of the method for manufacturing the toner of the present invention by means of the emulsion aggregation among the other wet methods is to be described. The wet toner may be obtained by mixing binding agent dispersion, colouring agent dispersion, and release agent dispersion, in each of which the binding agents, the colouring agents, and the release agent including the release agent for toner of the present invention are dispersed in an aqueous medium. The agents are let aggregate and heated at the temperature higher than the glass transition of the binding agent forming resin into an integrated molten form. Water may be the sole aqueous medium and, alternatively, the medium may contain such organic solvents as alcohols like methanol, isopropyl alcohol, and ethylene glycol, dimethylformamide, tetrahydrofuran, cellosolves like methyl cellosolve, and ketones like acetone and 2-butanone. For this purpose, the release agent including the release agent for toner of the present invention may be prepared beforehand in the form of water dispersion. The preferred particle size of the mixed binding agent dispersion, colouring agent dispersion, and release agent dispersion containing the release agent for toner of the present invention may be determined depending on the targeted particle size of the toner, and should be between 0.05 μm and 1 μm, more preferably 0.1 μm and 0.4 μm. The electrical charges of the aggregating particles may be controlled in advance by neutralization.

The application of the toner of the present invention is not restricted to specific developing methods. When the toner contains fine magnetic powder the toner may be solely applied for a single component magnetic developing toner. When the toner does not contain fine magnetic powder the toner may be applied for a two component developing reagent to be mixed with a single component non-magnetic developing toner, a two component developing toner, or a carrier.

The toner of the present invention may be applied to various fixing methods such as oil-less or oil-applied heat roll method, flash fixing method, oven method, and pressure fixing method.

### EXAMPLES

In the following sections, more concrete description of the invention of the present application is presented demonstrating how the invention is implemented into practice. The examples, however, should not be deemed to limit the scope of the invention of the present invention. Firstly, the description of the determination of various properties of the release agent for toner and the toner is presented.

(1) Weight average molecular weight (Mw) and molecular weight distribution (Mw/Mn) were determined by the method already mentioned in the previous sections.
(2) Measurement of the melting point by means of differential scanning calorimetry was carried out as described in the previous sections.
(3) Glass transition temperature of the binding agents employed in the preparation of the toner was determined as follows.

For the determination of the glass transition temperature a differential scanning calorimeter (produced by SIT NanoTechnology Inc: DSC-22) was used with the temperature profile of heat-up to 120° C., retention at 120° C. for 10 minutes, cool-down at 10° C./min to 10° C., retention at 10° C. for 10 minutes, and heat-up at 10° C./min. The glass transition temperature was determined as the temperature represented by the intersection of the line extended from the baseline in the lower temperature range than the glass transition temperature and the tangent line to the peak trace of DSC with the maximum slope between the onset and the top of the peak.

(4) Measurement of the softening point of the binding agents used for the toner preparation was conducted by the following method.

A Koka type flowtester (CFT-500D, produced by Shimadzu Corporation) was employed to extrude 1 g of sample through a 1 mm long nozzle with the diameter of 1 mm under the load of 0.5 MPa applied by a plunger while the specimen was heated at 4° C./min. In the coordinates of temperature and the amount of descent of the plunger (melt index), the softening point was determined as the temperature corresponding to h/2, wherein “h” represents the height of the produced S-shaped trace in the coordinates.

(5) Measurement of the 2-butanone insoluble component; A dispersion of the release agent for toner dispersed in 2-butanone with the content of 15 mass % was stirred at 25° C. for one hour. Subsequently, the soluble component was filtered out leaving the insoluble component, which was dried and weighed to calculate the content in mass % of the insoluble component as the mass ratio between the insoluble component and the original release agent for toner.
(6) Measurement of low temperature fixing properties of the toner;

The measurement of low temperature fixing properties was carried out with a fixing device having a temperature variable fixing roller with no silicon oil applied on the surface and with the rolling rate set at 100 mm/sec. The fixing temperature was taken as the lowest temperature at which the toner was fixed on the sheet of paper during the image fixing process of the toner on paper. The properties of dry toners were judged according to the following criterion.

A: The fixing temperature lower than 120° C. Good low temperature-fixing property.
B: The fixing temperature between 120° C. or higher and lower than 140° C.
C: The fixing temperature of 140° C. or higher. Poor low temperature fixing property.

The properties of wet toners were judged according to the following criterion.

A: The fixing temperature lower than 130° C. Good low temperature fixing property.
B: The fixing temperature between 130° C. or higher and lower than 150° C.
C: The fixing temperature of 150° C. or higher. Poor low temperature fixing property.
(7) Measurement of anti-hot-offset properties of dry toners.

The offset starting temperature was taken as the highest temperature at which the toner was transferred to the fixing roller during the image fixing process under the same conditions as the measurement of the low temperature fixing properties. The anti-hot-offset properties were judged according to the following criterion.

A: The offset starting temperature of 220° C. or higher. Good anti-hot-offset property.
B: The offset starting temperature between 200° C. or higher and lower than 220° C. Practically viable anti-hot-offset property.
C: The offset starting temperature lower than 200° C. Poor anti-hot-offset property.
(8) Measurement of the anti-blocking properties of dry and wet toners

After the toners were kept standing at the temperature of 50° C. for three days, the extent of the agglomeration of the toner powder was visually observed to judge the anti-blocking properties according to the following criterion.

A: No blocking was observed (practical use level).
B: A partial blocking was observed.
C: An extensive blocking was observed.
(9) Measurement of the dispersibility of the release agent

After a foil was prepared from the molten mixture of the ingredients of the toners, said foil was observed for the agglomerated cluster of the release agent with a microscope to judge the dispersibility according to the following criterion.

A: No agglomerated cluster of 2 μm or larger was observed.
C: An agglomerated cluster of 2 μm or larger was observed.

Preparation of α-olefin polymer A1 with the melting point of 58° C.

In a dry, hot 1 liter autoclave, the mixture (400 ml) prepared by mixing of α-olefins with the number of carbon atoms of 20 (43 mol %), 22 (36 mol %), and 24 (21 mol %) was placed and heated up to the polymerization temperature of 110° C. Subsequently, triisobutylaluminium (0.5 mmol), (1,2′-dimethylsilylene)(2,1′-dimethylsilylene)bis-(3-trimethylsilylmethylindenyl)zirconium dichloride (1 μmol), and dimethylaniliniumtetrakispentafluorophenylborate (4 μmol) were added and hydrogen gas was introduced under 0.1 MPa to carry out the polymerization for 120 minutes. After the polymerization was completed, the reaction product was precipitated in acetone. The collected precipitates were heated and vacuum dried to provide the copolymer of α-olefin polymer A1 (210 g). GPC determined the weight average molecular weight (Mw) of A1 as 14,000 and the molecular weight distribution (Mw/Mn) as 1.8. A1 had a melting point of 58° C. The only one peak having the half height width of 8.2° C. was observed as representing the melting point.

Preparation of α-olefin polymer A2 with the melting point of 73° C.

In a dry, hot 1 liter autoclave, the mixture (400 ml) prepared by mixing of α-olefins with the number of carbon atoms of 26 (62 mol %) and 28 (38 mol %) was placed and heated up to the polymerization temperature of 130° C. Subsequently, triisobutylaluminium (0.5 mmol), (1,2′-dimethylsilylene)(2,1′-dimethylsilylene)bis(3-trimethylsilylmethylindenyl)-zirconium dichloride (1 μmol) and dimethylaniliniumtetrakispentafluorophenylborate (4 μmol) were added and hydrogen gas was introduced under 0.2 MPa to carry out the polymerization for 120 minutes. After the polymerization was completed, the reaction product was precipitated in mixed solvent of acetone and 2-butanone. The collected precipitates were heated and vacuum dried to provide the copolymer of α-olefin polymer A2 (180 g). GPC determined the weight average molecular weight (Mw) of A2 as 8,000 and the molecular weight distribution (Mw/Mn) as 1.8. A2 had a melting point of 73° C. The only one peak having the half height width of 6.0° C. was observed as representing the melting point.

### Example 1

In a 1 liter four necked flask equipped with a Dimroth condenser, a thermometer, a nitrogen inlet tube, and a stirrer, 120 g of α-olefin polymer A1 was placed to be melt by raising the temperature to 190° C. with the introduction of nitrogen. After 40 g of styrene and 2 g of dicumylperoxide were added during the space of time of 1 hour, the reaction mixture was retained at 190° C. for 1 hour. A following vacuum distillation with the pressure of 7 hPa at 190° C. for 1 hour provided the release agent for toner R1. R1 had 85 mass % of 2-butanone insoluble component, the melting point (Tm) of 52° C., which was represented by a single DSC peak having the half-height width of 8.3° C., and the weight average molecular weight (Mw) of 43,000.

### Example 2

The release agent for toner R2 was provided in the same method as example 1 except that the α-olefin polymer A2 was used instead of A1.

R2 had 87 mass % of 2-butanone insoluble component, the melting point (Tm) of 70° C., which was represented by a single DSC peak having the half-height width of 6.0° C., and the weight average molecular weight (Mw) of 9,000.

### Example 3

In a 1 liter four necked flask equipped with a Dimroth condenser, a thermometer, a nitrogen inlet tube, and a stirrer, 120 g of α-olefin polymer A2 was placed to be melt by raising the temperature to 160° C. with the introduction of nitrogen. After 80 g of styrene and 4 g of dicumylperoxide were added during the space of time of 1 hour, the reaction mixture was retained at 160° C. for 1 hour. A following vacuum distillation with the pressure of 7 hPa at 190° C. for 1 hour provided the release agent for toner R3. R3 had 74 mass % of 2-butanone insoluble component, the melting point (Tm) of 67° C., which was represented by a single DSC peak having the half-height width of 6.0° C., and the weight average molecular weight (Mw) of 20,000.

### Comparative Example 1

Carnauba wax, which has the melting point of 85° C., was employed as the release agent for toner RR1.

### Comparative Example 2

A mixture of 70 parts by mass of the selected fine powder of α-olefin polymer A2 screened for the particle size of 30 mesh or smaller and 30 parts by mass of low molecular weight polystyrene having the Mw of 3,000 was employed as the release agent for toner RR2.

### Comparative Example 3

The 2-butanone soluble component of the release agent for toner R2 was extracted and added to a separately prepared original R2 described in example 2 so that the newly prepared composition had 50 mass % of 2-butanone soluble component. The prepared composition was employed as the release agent for toner RR3.

### Preparation of Toner

### Example 4

89 parts by mass of polyester as a binding agent having the glass transition temperature of 57.9° C., the softening point of 117.4° C., and the Mw of 48,000, 7 parts by mass of the release agent for toner R1, 4 parts by mass of carbon black, and 2 parts by mass of a charge control agent (T-77 produced by Hodogaya Chemical Co., Ltd.) were mixed in a blender to be further melted and kneaded in a twin screw extruder. The melt composition was cooled and crushed with a speed mill into coarse granules, which were subsequently finely grinded with a jet mill. The obtained fine granules were screened with precision by a classifier to provide toner particles having the volume average particle sizes of 10 μm or smaller. Subsequently, 100 parts by mass of the toner particles and 1 part by mass of colloidal silica (AerosolR972, product of Nippon Aerosil Co., Ltd) were mixed in a mixer to provide toner T1.

### Example 5

Toner T2 was provided in the same method as example 4 except that the release agent R1 was replaced with R2.

### Example 6

Toner T3 was provided in the same method as example 4 except that the release agent R1 was replaced with R3.

### Example 7

Toner T4 was provided in the same method as example 4 except that the amount of the binding agent was 86 parts by mass and the amount of the release agent was 10 parts by mass.

### Comparative Example 4

Toner TR1 was provided in the same method as example 4 except that the release agent R1 was replaced with RR1.

### Comparative Example 5

Toner TR2 was provided in the same method as example 4 except that the α-olefin polymer A2 was employed as a release agent for toner instead of R1.

### Comparative Example 6

Toner TR3 was provided in the same method as example 4 except that the release agent R1 was replaced with RR2.

### Comparative Example 7

Toner TR4 was provided in the same method as example 4 except that the release agent R1 was replaced with RR3.

TABLE 1
Table 1

| | | | Amount of | Properties of release agent | | | | | | |
|---|---|---|---|---|---|---|---|---|---|---|
| | | | Release | 2-butanone | | | Properties of toner | | | |
| | | | agent | insoluble | | | Low | | | |
| | | Release | (parts | by component | Tm | Half-height | temperature | Anti | Anti | Release agent |
| | Toner | agent | mass) | (mass %) | (° C.) | width (° C.) | fixing | hot-offset | blocking | dispersibility |
| Example 4 | T1 | R1 | 7 | 85 | 52 | 8.3 | A | A | A | A |
| Example 5 | T2 | R2 | 7 | 87 | 70 | 6.0 | A | A | A | A |
| Example 6 | T3 | R3 | 7 | 74 | 67 | 6.0 | A | A | A | A |
| Example 7 | T4 | R2 | 10 | 87 | 70 | 6.0 | A | A | A | A |
| Comparative | TR1 | RR1 | 7 | 100 | 85 | 11.0 | A | C | A | C |
| example 4 | | | | | | | | | | |
| Comparative | TR2 | A2 | 7 | 100 | 73 | 6.0 | A | C | A | C |
| example 5 | | | | | | | | | | |
| Comparative | TR3 | RR2 | 7 | 70 | 73 | 6.0 | A | A | C | C |
| example 6 | | | | | | | | | | |
| Comparative | TR4 | RR3 | 7 | 50 | 34/70 | — | C | C | C | C |
| example 7 | | | | | | | | | | |

Table 1 shows the measurement results of the properties of the dry toners prepared by kneading pulverization as a dry method. Example 4, 5, 6, and 7 show the toners containing R1, R2, or R3 have superior anti-hot-offset properties, that are induced by the styrene modification, to comparative example 4, which employs the toner containing the conventional release agent RR1 that is a widely used release agent for toner. The examples also show superior anti-hot-offset properties and release agent dispersibilities to comparative example 5 which employs the toner containing α-olefin polymer A2. Moreover, the examples, which have superior anti-blocking properties and release agent dispersibilities, to comparative example 6, which employs the toner containing RR2 prepared by mixing polystyrene—a styrene type polymer—and α-olefin polymer A2, reveals that the modification is more advantageous than the mixing in providing an excellent release agent for toner. Comparative example 7 presents the result of the toner, which has a high 2-butanone soluble content due to the additionally mixed 2-butanone soluble component. The comparative example showing an inferior low temperature fixing property, anti-hot-offset property, anti-blocking property, and release agent dispersibility reveals that a lower content of 2-butanone soluble component means a toner with superior properties.

### Example 8

In a 1 liter separable flask, were placed 336.6 parts by mass of deionized water and 5.2 parts by mass of Na₃PO₄. The temperature was set at 70° C. While the composition was stirred with a TK-homo mixer (product of PRIMIX Corporation) at 10,000 rpm, 3.0 parts by mass of CaCl₂ was added by bits to prepare an aqueous dispersion containing Ca₃(PO₄)₂ as a dispersion stabilizer. To the cooled dispersion to the room temperature, were added a separately prepared mixture of 71.8 parts by mass of styrene as a binding agent, 18.0 parts by mass of n-butylacrylate, 0.2 parts by mass of divinylbenzene, 3.0 parts by mass of Pigment Red 122 as a pigment, 1.5 parts by mass of BONTRONE E-88 (product of Orient Chemical Industries Co. Ltd.) as a charge control agent, 7.0 parts by mass of the release agent for toner R1, and 5.2 parts by mass of 2.2′-azobis-isobutylvaleronitrile, maintaining the stirring rate of 10,000 rpm, then the composition was stirred for further 15 minutes. After dismantling the TK-homo mixer, a flask cover equipped with a stirrer, a nitrogen inlet tube, a thermometer, and a Dimroth condenser was put into place, then the flask was filled with nitrogen. The temperature was raised to 70° C. at which the reaction was carried out for ten hours. The reaction was continued at 90° C. for further 5 hours. After the reaction was completed, the acidity of the cooled composition was adjusted at pH1 with hydrochloric acid. The following filtration, cleaning, drying, and classification provided a powder with the particle size of 5 μm in volume average. Toner T5 was provided by mixing 100 parts by mass of the classified powder and 1 part by mass of colloidal silica (AerosolR972, product of Nippon Aerosil Co., Ltd.) in a mixer.

### Comparative Example 8

Toner TR5 was provided in the same method as example 8 except that release agent R1 is replaced with α-olefin polymer A1. The classified particles had the volume average particle size of 5 μm.

TABLE 2
Table 2

| | | | Amount of | Properties of release agent | | | | | |
|---|---|---|---|---|---|---|---|---|---|
| | | | Release | 2-butanone | | | Properties of toner | | |
| | | | agent | insoluble | | | Low | | |
| | | Release | (parts | component | Tm | Half-height | temperature | Anti | Release agent |
| | Toner | agent | by mass) | (mass %) | (° C.) | width (° C.) | fixing | blocking | dispersibility |
| Example 8 | T5 | R1 | 7 | 85 | 52 | 8.3 | A | A | A |
| Comparative | TR5 | A1 | 7 | 100 | 58 | 8.2 | A | A | C |
| example 8 | | | | | | | | | |

Table 2 shows the measurement results of the properties of the toners prepared by the suspension polymerization as a wet method. Example 8, which employs the release agent for toner of the present invention, had superior release agent dispersibility to comparative example 8 employing α-olefin polymer A1. The release agent for toner of the present invention is found to be applicable to wet toners as well as to dry toners.

1. A release agent for toner comprising styrene compounds graft to an α-olefin polymer, wherein 70 mass % or more of the release agent is insoluble in 2-butanone when the release agent is dispersed at 25° C. into 2-butanone so that the mass ratio of the release agent to the dispersion is 15%;
wherein the α-olefin polymer is to be produced by polymerization of at least one α-olefin monomer that has 16 or more to 36 or less carbon atoms;
wherein the α-olefin polymer is to have a melting point between 30° C. or higher and 80° C. or lower, and has one peak temperature whose peak has the half-height width of 15° C. or less in a measurement of the melting behavior of the α-olefin polymer by means of differential scanning calorimetry (DSC).

2. The release agent for toner of claim 1, wherein said release agent has a melting point between 30° C. or higher and 80° C. or lower, and has one peak temperature whose peak has the half-height width of 15° C. or less in a measurement of the melting behavior of the agent by means of differential scanning calorimetry (DSC).

3. A toner comprising the release agent for toner of claim 1, wherein the mass ratio of the release agent to the solid content of a biding agent is between 0.1 mass % or more and 40 mass % or less.

4. A toner comprising the release agent for toner of claim 2, wherein the mass ratio of the release agent to the solid content of a biding agent is between 0.1 mass % or more and 40 mass % or less.
